(19) United States
(12) Patent Application Publication
(10) Pub. No.: US 2012/0041332 A1
(43) Pub. Date: Feb. 16, 2012

(54) DEVICE AND METHOD FOR ORIENTAL MEDICINE DIAGNOSIS AND TREATMENT

(76) Inventors: Georgiy Lifshits, Skokie, IL (US); Yosef Lifshits, Skokie, IL (US)

(21) Appl. No.: 12/854,587

(22) Filed: Aug. 11, 2010

(51) Int. Cl. A61H 39/02

(52) U.S. Cl. 600/548

(57) ABSTRACT

Devices and methods for measuring and monitoring electrical properties related to acupuncture points in real time. Devices include a plurality of electrodes; a regulated voltage supply adapted to provide a voltage to one or more of the plurality of electrodes; and an output device adapted to output information based on measurements taken from each of the plurality of electrodes in approximately real time, wherein the information is adapted for use in oriental medicine diagnosis or treatment. Methods include affixing electrodes to a plurality of acupuncture points; measuring the current or resistance at each of the electrodes under regulated voltage; and outputting the measurements in real time. Additional methods include approximately simultaneously measuring the current or resistance at a plurality of acupuncture points under regulated voltage; and outputting the measurements in real time.

### BACKGROUND OF THE INVENTION

The present subject matter relates generally to a system and method for oriental medicine diagnosis and treatment. More specifically, the present invention relates to a system and method for monitoring electrical properties related to acupuncture points in real time to aid in the diagnosis and treatment of a patient.

Oriental medicine is the philosophy and science that views the human body as a set of complete, interconnected, systems that work together to achieve the proper function and health of the body. Although differing from one school of thought to another, the general concept relies on some superset of a subset of Yin, Yang, Qi, Blood, and/or the Zang-Fu organ or meridian system, as well as several other characteristics that determine health and illness in oriental medicine. Oriental medicine may also rely on the interactions of the Five Elements (i.e., Wood, Fire, Earth, Metal and Water). There are significant regional and philosophical differences between practitioners and schools which in turn can lead to differences in practice and theory. However, the term oriental medicine is an understood term of art for practitioners in the field.

According to Oriental medicine, meridians are channels along which the energy of the psychophysical system is considered to flow. Numerous acupuncture points exist along and are associated with the meridians. It is known that acupuncture points and meridians comprise electrical pathways through which and between which there is lower electrical impedance than between adjacent reference points. It is further known that stimulation of acupuncture points has an influence on their electrical properties, which then has an effect on the health of the person receiving treatment. Accordingly, Oriental medicine and the treatment of patients using Oriental medicine rely, at least in part, on monitoring and manipulating acupuncture points and meridians.

One of the major difficulties in practicing oriental medicine, particularly the diagnosis and treatment processes, is the difficulty in accurately measuring energy flow along the meridians and using the measurements to provide appropriate treatment. For example, it may be possible to measure the electrical properties of acupuncture points, but currently known methods and devices are inaccurate. For example, it is known that the pressure applied to the probes used to measure the electrical properties affects the measured values. As a result, to monitor changes in measurements over time, it is important to minimize the effects of variable pressure in taking measurements. Moreover, the inability of known methods to be used to monitor results in real time impedes the diagnosis and treatment process by requiring a doctor to take initial measurements, treat the patient and then take additional measurements to track the effects. Because of the variability in the measurement process and the inability to monitor in real time, the number of iterations of measurement and treatment required to reach a desired result may be burdensome.

A known method for the measurement and diagnosis of the excess or deficiency of energy in meridians is called Ryodoraku. Many devices exist that employ this method to measure the level of the excess or deficiency by measuring the current between points in a meridian. However, these methods and devices provide inadequate and inaccurate readings due to the variation is the pressure exerted on the active electrode by the person performing the measurements. In addition, there is a large possibility of error if an electrode is placed not in the ideal place, thus resulting in a larger value of resistance and therefore lower conductivity, indicating a false deficiency. Further, it takes a long time to perform a full measurement, because the person operating the active electrode must sequentially traverse all 24 pre-defined acupuncture points and measure the data at each one in order to achieve a complete measurement. As the measurements are performed sequentially, and the time between measuring the first point and the next point, and especially the last point, can be large, there may be additional inaccuracy in the resulting measurements. Due to the necessity of sequential measurements, the known methods and devices are not able to account for the dynamics of the conductivity of the meridians, nor are they able to provide this data during the diagnosis and treatment. Considering the limitations of the amount of time the procedure takes, the inaccuracy of the measurements, the addition of errors in measurement as well as the inability to evaluate the dynamics of the state of the meridians, it can be seen that an accurate diagnosis and treatment cannot be determined and performed using known devices and methods.

Accordingly, a need exists for a device and method for monitoring electrical properties related to acupuncture points in real time to aid in the diagnosis and treatment of a patient as described and claimed herein.

### BRIEF SUMMARY OF THE INVENTION

The subject matter disclosed herein addresses these issues by providing a device and method for monitoring electrical properties related to acupuncture points in real time to aid in the diagnosis and treatment of a patient. The device and method allow the practitioner to monitor the condition of the patient and view the effects of the treatment in real time.

The device and method are used to determine the energetic state of the meridians, reduce the measurement time, reduce human error in performing the measurements, eliminate the problems caused by the time difference of the measurements at various points, to account for the dynamics of the meridian state for diagnosis, as well as throughout the treatment thus allowing to dynamically correct the treatment as it is performed.

In one contemplated embodiment, the device includes a plurality of electrodes to be attached to a patient's skin at acupuncture points, a regulated voltage source supplying voltage to the electrodes and an output display for indicating the current measured at each electrode. The current at each electrode is measured and output approximately simultaneously.

The output data may be used to output a diagnosis and a treatment plan for the patient. Moreover, in contrast with existing methods, because the device continuously monitors for any changes that occur, the device may be used to modify the diagnosis and the treatment plan in real time, if modifications are necessary. In addition, it is contemplated that supplemental elements may be included, for example, a storage medium that records data for later processing or historical analysis.

In an example, a device includes: a plurality of electrodes; a regulated voltage supply adapted to provide a voltage to one or more of the plurality of electrodes; and an output device adapted to output information based on measurements taken from each of the plurality of electrodes in approximately real time, wherein the information is adapted for use in oriental medicine diagnosis or treatment.

In another example, a method includes the steps of: affixing electrodes to a plurality of acupuncture points; measuring the current or resistance at each of the electrodes under regulated voltage; and outputting the measurements in real time.

In yet another example, a method includes the steps of: approximately simultaneously measuring the current or resistance at a plurality of acupuncture points under regulated voltage; and outputting the measurements in real time.

An advantage of the devices and methods provided herein is to accurately measuring energy flow along the meridians and using the measurements to provide appropriate treatment.

Another advantage of the devices and methods provided herein is to improve the accuracy of measured electrical properties of acupuncture points.

A further advantage of the devices and methods provided herein is to minimize the effects of variable pressure applied to the acupuncture points when taking measurements.

Additionally, an advantage of the devices and methods provided herein is to monitor the measurements in real time.

Moreover, an advantage of the devices and methods provided herein is to reduce the number of iterations of measurement and treatment required to reach a desired result.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a device as described herein.

FIG. 2 is a flow chart of a method as described herein.

### DETAILED DESCRIPTION OF THE INVENTION

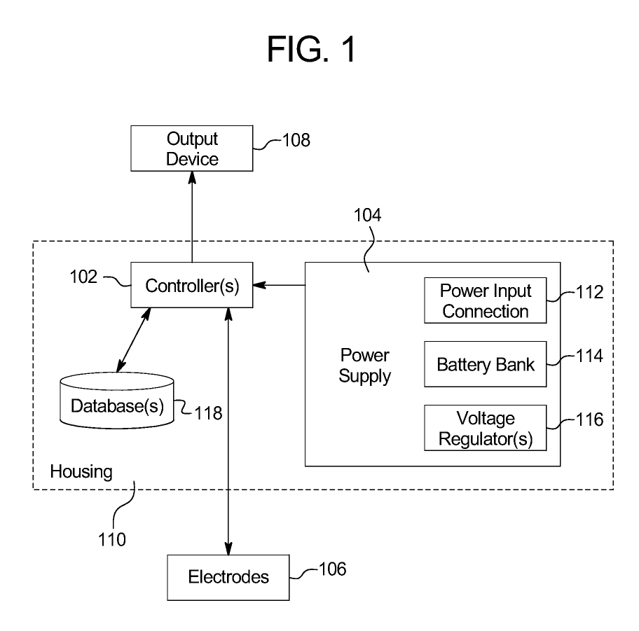

Devices and methods for monitoring electrical properties related to acupuncture points in real time are described herein. FIG. 1 illustrates a device 100 for monitoring electrical properties related to acupuncture points in real time to aid in the diagnosis and treatment of a patient. As shown in FIG. 1, the device 100 includes one or more controllers 102, a power supply 104, a plurality of electrodes 106 and an output device 108. The device 100 shown is a single unit with a housing 110 enclosing the one or more controllers 102, the power supply 104 and the output device 108. However, it is understood that the constituent elements of the device 100 may be embodied in any number of discreet units.

The one or more controllers 102 shown in FIG. 1 are a plurality of microprocessors adapted to control and perform the various functions of the device 100. As shown in FIG. 1, the microprocessors are located within a housing 110. However, it is understood that in various embodiments of the invention, the one or more controllers 102 may be located in multiple housings or may be resident, for example, in a separate computer to which the device 100 is an accessory. In such embodiments, the device 100 may be a dummy peripheral while all of the control logic and processing is performed in the computer with which the device 100 is associated.

The power supply 104 shown in FIG. 1 is adapted to provide power to the various elements of the device 100. For example, the power supply 104 may provide power to the one or more controllers 102, the plurality of electrodes 106 and the output device 108. As further shown in FIG. 1, the power supply 104 may be resident within the housing 110. However, it is understood that the power supply 104 may be more specifically adapted to power only specific elements of the device 100 and/or may be provided in a discreet unit.

The power supply 104 shown in FIG. 1 includes a power input connection 112, a battery bank 114 and voltage regulators 116. The power input connection 112 may be adapted to receive an AC wall voltage, a transformed DC voltage or any other input power as will be understood by one of ordinary skill in the art. For example, in the embodiment shown in FIG. 1, the power supply 104 is adapted to receive an AC voltage from a typical one hundred twenty volt commercial/residential wall outlet and the power supply 104 is further adapted to receive a DC voltage through a universal serial bus (“USB”) connection. It is further understood that the battery bank 114 is not a requirement of a power supply 104 for the device 100; however, it is contemplated that the battery bank 114 may be useful in regulating voltages, maintaining operation when the wall voltage fluctuates or is not available, etc.

As shown in FIG. 1, the power supply includes a pair of voltage regulators 116. The pair of voltage regulators 116 shown includes a five volt regulator and a twelve volt regulator. Each voltage regulator 116 is adapted to regulate a voltage provided to the plurality of electrodes 106 when the device 100 is in use. As described above, the embodiment of the device 100 shown in FIG. 1 includes a power supply 104 adapted to receive power from a high voltage AC source, as well as a low voltage DC source, such as, for example, a USB connection. It is contemplated that the device 100 may be powered entirely from either power source. Accordingly, in some instances, it may be most appropriate to run the plurality of electrodes 106 at approximately five volts, for example, when the device 100 is being solely powered by the USB connection and other times run the plurality of electrodes 106 at approximately twelve volts, for example, when a higher voltage source is available. Although it is understood that the power supply 104 may include any number of voltage regulators 116 for regulating voltage at any number of voltages, it is understood that higher voltages enable the plurality of electrodes 106 to be operated more accurately and that too high a voltage may be dangerous to the person to which the plurality of electrodes 106 are attached. Accordingly, the design choice of selecting five volts is based on using a USB connection as a power source and the design choice of selecting twelve volts is based on a balance of accuracy in measurements and safety to the person.

The plurality of electrodes 106 shown in FIG. 1 includes twenty five bioadhesive diagnostic electrodes 106. However, the bioadhesive diagnostic electrodes 106 shown in FIG. 1 are merely one example of an electrode 106 suitable for providing the advantages of the present invention. For example, any electrode 106 that may be temporarily affixed to the patient in such a manner as to reduce the effect of variable and varying pressure being applied to the electrodes 106 while measuring the electrical properties of a given point over time may be particularly appropriate for the present invention. For example, the electrodes may include one or more needles inserted into acupoints. In addition, any electrode 106 that is capable of measuring electrical characteristics over a surface area as opposed to approximately at a point may make it easier for application of the electrode 106 to a particular acupuncture point. It is understood that electrodes 106, such as the bioadhesive diagnostic electrodes 106 described herein, allow the device 100 to make quality measurements of the electrical characteristics of acupuncture points as long as the point is covered by a portion of the electrode 106. In other words, the greater surface area of the electrode 106 may reduce the necessity of precision placement of the electrode 106 on the patient. An increased margin of error may make the device 100 easier to operate and easier to achieve meaningfully relevant measurements.

In the example shown in FIG. 1, twenty five electrodes 106 are used to measure twenty four acupuncture points, with the remaining electrode 106 to be used as a reference electrode 106 for providing a reference voltage. However, it is understood that any number of electrodes 106 may be used and that the reference voltage may be provided by any one or more electrodes 106 or in any manner.

In the example shown in FIG. 1, each of the electrodes 106 adapted to measure electrical characteristics at an acupuncture point. It is contemplated that the electrodes 106 may be adapted to measure resistance at the acupuncture point under a regulated voltage provided through the reference electrode 106. However, it is understood that the electrodes 106 may be adapted to measure the current or other electrical characteristics as will be understood by one of ordinary skill in the art.

The output device 108 shown in FIG. 1 is a video monitor 108. The video monitor 108 is adapted to display the electrical characteristics measured by the electrodes 106. The measurement at each electrode may be displayed as a unique output shown in real time or approximately real time on the video monitor 108. Accordingly, as the electrodes 106 are placed and replaced, the electrical characteristics may be monitored to improve the placement of the electrodes 106. Further, as treatments are performed on the patient, the electrical characteristics may be monitored to assess the patient's response to the treatment. In addition, while the device 100 is shown with a video monitor 108 as the output device 108, it is contemplated that the output device may be a video output device, an audio output device, an electrical output device, a data output device or any combination thereof. For example, the output device 108 may alert a user to the measured conditions using audio signals. Further, the output device 108 may transfer the measured data to a database 118 for storing the measured data for later analysis and/or record keeping.

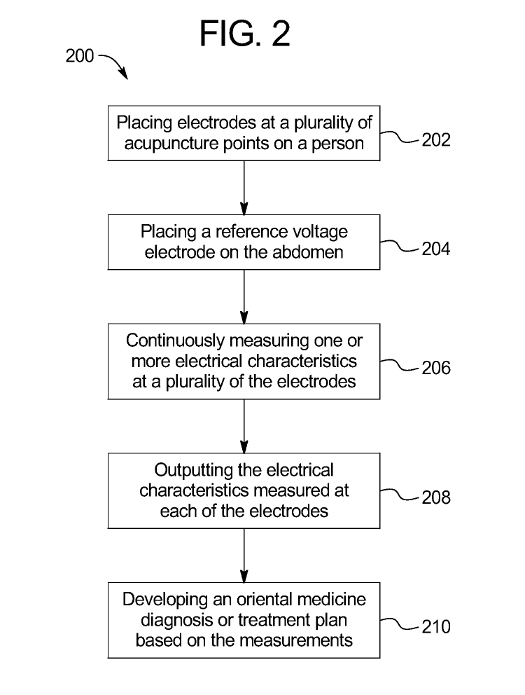

Turning now to FIG. 2, a method 200 for monitoring electrical properties related to acupuncture points in real time is shown. As shown in FIG. 2, the method 200 includes the steps of: placing electrodes at a plurality of acupuncture points on a person (step 202); placing a reference voltage electrode on the abdomen (step 204); continuously measuring one or more electrical characteristics at a plurality of the electrodes (step 206); outputting the electrical characteristics measured at each of the electrodes in approximately real time (step 208); and developing an oriental medicine diagnosis or treatment plan based on the measurements (step 210). It is contemplated that the device 100 shown in FIG. 1 and the various embodiments described herein may be utilized to accomplish the method 200 shown in FIG. 2.

The step of developing an oriental medicine diagnosis or treatment plan based on the measurements (step 210) may include utilizing an automated program that receives the output electrical characteristics measured at the electrodes (step 208) as input and uses the input characteristics, with or without additional information about the patient, to and using the electrical characteristics to automatically develop an oriental medicine diagnosis or treatment plan for the patient. Accordingly, as the electrical measurements are output in approximately real time, the diagnosis and/or treatment plan may be updated in real time to more accurately reflect the current state of the patient. For example, a patient may be monitored using a device 100 as described herein to send input signals to a computer program that develops the appropriate oriental medicine diagnosis and treatment plan, including recommended treatments, based on the measured characteristics from the device 100. Then, as the user carries out the recommended treatments, the computer program updates the diagnosis and treatment plan providing further recommended treatments. Over time, the user and the program iterate until the treatments are effective to address the identified diagnosis.

For example, electrodes 106 may be attached to a patient's meridians and the device 100 may provide a graphical display to the user via the output device 108. The graphical display may indicate which meridians are deficient and which are excess. In addition, the output device 108 may provide textual information and/or computed scores for the measured points. The output device 108 would illustrate the current measurements of the patient. The textual information could include, for example, treatment recommendations (e.g., tonify the large intestine by needling the source point LI-4). As the patient is treated, the patient's energy balance changes and the output device 108 reflects those changes. The changing measured values result in changing treatment recommendations. For example, the treatment recommendations may be updated at set intervals (e.g., updated every three minutes of treatment). The dynamic iterative treatment may be provided over a set amount of time and the data may be collected stored and used over the course of several treatment sessions.

In addition to the acupuncture treatment scenarios described above, it is contemplated that device 100 and method 200 described herein may be adapted to be used in situations in which a user may wish to monitor the body's response to activity, exercise, stress, etc. For example, under physical training, a user may monitor the state of the measured channels as the trainee performs various activities.

As shown by the above description, aspects of the devices 100 and methods 200 for monitoring electrical properties related to acupuncture points in real time to aid in the diagnosis and treatment of a patient are controlled by one or more controllers 102, which will now be described as a single controller 102 for purposes of grammatical clarity. As described above, the controller 102 may control various operations of the device 100, for example, the measurement process through the plurality of electrodes 106 and the output of information through the output device 108. Typically, the controller 102 is implemented by one or more programmable data processing devices. The hardware elements operating systems and programming languages of such devices are conventional in nature, and it is presumed that those skilled in the art are adequately familiar therewith.

For example, the controller 102 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM, or the like. The system also includes mass storage devices such as various disk drives, tape drives, etc. In operation, the main memory stores at least portions of instructions for execution by the CPU and data for processing in accord with the executed instructions.

The controller 102 may also include one or more input/output interfaces for communications with one or more processing systems. Although not shown, one or more such interfaces may enable communications via a network, e.g., to enable sending and receiving instructions electronically. The physical communication links may be wired or wireless.

The controller 102 may further include appropriate input/output ports for interconnection with one or more outputs (e.g., output device 108, monitors, printers, speakers, etc.) and one or more inputs (e.g., plurality of electrodes 106, keyboard, mouse, voice, touch, bioelectric devices, etc.). For example, the controller 102 may include a graphics subsystem to drive the output display. The links of the peripherals to the system may be wired connections or use wireless communications.

Although summarized above as a PC-type implementation, those skilled in the art will recognize that the controller 102 also encompasses stand alone systems, as well as host computers, servers, workstations, network terminals, and the like. In fact, the use of the term controller 102 is intended to represent a broad category of components that are well known in the art.

Aspects of the devices 100 and methods 200 for monitoring electrical properties related to acupuncture points in real time to aid in the diagnosis and treatment of a patient described herein encompass hardware and software for controlling the relevant functions. Software may take the form of code or executable instructions for causing a controller 102 or other programmable equipment to perform the relevant steps, where the code or instructions are carried by or otherwise embodied in a medium readable by the controller 102 or other machine. Instructions or code for implementing such operations may be in the form of computer instruction in any form (e.g., source code, object code, interpreted code, etc.) stored in or carried by any readable medium.

As used herein, terms such as computer or machine “readable medium” refer to any medium that participates in providing instructions to a processor for execution. Such a medium may take many forms, including but not limited to, tangible storage media, as well as carrier wave and tangible transmission media. Non-volatile storage media include, for example, optical or magnetic disks, such as any of the storage devices in any computer(s) shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A device comprising:
a plurality of electrodes;
a voltage supply adapted to provide a regulated voltage to one or more of the plurality of electrodes;
an output device adapted to output information based on measurements taken from the plurality of electrodes in approximately real time, wherein the information is adapted for use in oriental medicine diagnosis or treatment.

2. The system of claim 1 wherein the plurality of electrodes are adapted to measure amperage at a plurality of points on a person's body.

3. The system of claim 1 wherein the plurality of electrodes includes twenty five electrodes.

4. The system of claim 1 wherein the electrodes are bioadhesive diagnostic electrode pads.

5. The system of claim 1 wherein the output device is a video display.

6. The system of claim 1 wherein the information displayed includes electrical measurements made via the electrodes displayed in real time via the output device.

7. The system of claim 1 wherein the information displayed includes the current measured at each electrode.

8. The system of claim 1 wherein the information displayed includes an oriental medicine diagnosis based on measurements taken via one or more of the electrodes.

9. The system of claim 1 wherein the information displayed includes an oriental medicine treatment based on measurements taken via one or more of the electrodes.

10. The system of claim 1 wherein one of the plurality of electrodes is a reference voltage electrode.

11. A method comprising the steps of:
affixing a plurality of electrodes to a plurality of acupuncture points of a person;
measuring the current or resistance at each of the electrodes under regulated voltage; and
outputting the measurements in real time.

12. The method of claim 11 wherein the electrodes are bioadhesive diagnostic electrodes.

13. The method of claim 11 wherein one of the electrodes is a reference voltage electrode.

14. The method of claim 11 wherein the current at each electrode is measured in real time.

15. The method of claim 11 wherein the measurements at each electrode are taken approximately simultaneously.

16. The method of claim 11 further including affixing a base electrode to the abdomen of the person.

17. A method comprising the steps of:
approximately simultaneously measuring the current or resistance at a plurality of acupuncture points under regulated voltage; and
outputting the measurements in real time.

18. The method of claim 17 wherein the measurements are output and displayed on a video monitor.

19. The method of claim 17 wherein current is measured at each of twenty four acupuncture points.

20. The method of claim 17 further including the step of developing an oriental medicine diagnosis or treatment plan based on the measurements.
